(19) United States
(12) Patent Application Publication
(10) Pub. No.: US 2020/0234589 A1
(43) Pub. Date: Jul. 23, 2020

(54) METHOD FOR ASCERTAINING AND/OR MANAGING A PARKING SPACE MAP

(71) Applicant: AUDI AG, Ingolstadt (DE)

(72) Inventor: Franz MIRLACH, Lenting (DE)

(73) Assignee: AUDI AG, Ingolstadt (DE)

(21) Appl. No.: 16/489,959

(22) PCT Filed: Mar. 12, 2018
(86) PCT No.: PCT/EP2018/056021

§ 371 Date: Aug. 29, 2019

(30) Foreign Application Priority Data
Mar. 14, 2017 (DE) 10 2017 204 180.3

(51) Int. Cl. G08G 1/14; G01C 21/36; G05D 1/02; G01S 19/42

(52) U.S. Cl. CPC G08G 1/142; G01S 19/42; G05D 1/0225; G01C 21/3685

(57) ABSTRACT

Method for ascertaining and/or managing a parking space map describing states of occupancy of parking spaces for a motor vehicle in a parking space area in a motor vehicle-external server device,

wherein a position sequence covering a predetermined operating section of geodetic positions and/or positions relatable to geodetic positions that are visited by the motor vehicle, which position sequence is transmitted to the server device when a parking criterion indicating parking of the respective motor vehicle occurs, is recorded inside motor vehicles of a vehicle fleet communicating with the server, wherein the server device checks upon receipt of a position sequence, whether the position sequence describes a parking trajectory on a parking space that is managed or to be managed, and marks the parking space described by the final position in the position sequence as occupied when a parking trajectory is detected.

### TECHNICAL FIELD

The application relates to a method for ascertaining and/or managing a parking space map.

### BACKGROUND

To assist drivers of motor vehicles, a variety of support systems have been proposed which use, for example, software applications (apps) in order to provide drivers with pieces of information and services regarding parking spaces. The pieces of information provided are usually related to a local environment, thus based, for example, on a parking space map that includes a plurality of parking spaces. Thus, for example, drivers may be provided pieces of information such as the location of a parking space, prices for parking and/or opening hours. Pieces of information relating to parking spaces and parking environments may therefore be retrieved via a software application on the smartphone and/or via display devices in the motor vehicle. In addition, such software applications may be utilized, for example, to navigate to desired destination parking spaces and/or to pay parking fees. Such a software application may also indicate to a driver the availability of a parking space and/or of a parking environment, for example, a parking space or parking garage, in order to prevent the driver from driving to an already occupied parking space or to a fully occupied parking environment.

It has been proposed in the prior art to determine the availability, and thus the state of occupancy, of a parking space by ascertaining the location of the smartphone/of the motor vehicle when paying via a software application, according to which the parking space is marked as occupied for the time booked in a motor vehicle-external server device that manages the parking space map.

DE 10 2011 003 886 A1 proposes to provide a device for a vehicle for creating a piece of driving situation information, which device includes an evaluation unit for ascertaining a parking process of the vehicle by evaluating one or multiple driving state variables, and a communication unit for transmitting pieces of information about the ascertained parking process. Vehicle state data in this case may include a speed of the vehicle, an acceleration of the vehicle, a turn signal position of the vehicle, a steering wheel position of the vehicle, a gear selection position of the vehicle, navigation data and/or position data of a driver information system of the vehicle, surroundings data from surroundings sensors of the vehicle or driving situation data transmitted from other road users to the vehicle. It is apparent that a highly complex evaluation is carried out in order to provide, for example, infrastructure facilities with pieces of information that can be used for identifying parking space occupancy.

DE 10 2013 203 909 A1 relates to a method and a mobile terminal for detecting a parking space, wherein it is proposed to detect whether the mobile terminal is introduced into or leaves a motor vehicle, it being determined when leaving the motor vehicle whether the position indicates an occupied parking space, wherein a corresponding position is transmitted to a central server. Accordingly, when introduced in a motor vehicle, it may also be checked whether the position indicates a parking space and then a clearing is transmitted to the central server. This parking space in this case must already be known in a parking space map on the server.

Another possibility proposed in the prior art for ascertaining parking spaces is based on an interpretation of movement trajectories. For this purpose, GPS positions of smartphones on which a software application is installed as described above, are often used, but which are very inaccurate. Moreover, a smartphone is generally unable to determine with absolute certainty whether the vehicle has been parked. Thus, based on simple pieces of position information, it is possible to only conjecture whether a parking process has taken place.

Nor is this changed by a design in which a motor vehicle regularly, for example, every minute or every two minutes, sends its position to a motor vehicle-external server device, so that the server device is able monitor the flow of traffic and to identify congestion situations. The collected position data namely are chronologically so far apart as to render an analysis with regard to parking impossible; however, such a data reduction is necessary in order to reduce the amount of data being transmitted from the motor vehicle to the server device.

### BRIEF DESCRIPTION OF THE DRAWINGS

FIG. 1 shows a flowchart of one exemplary embodiment of the method according to the application.

FIG. 2 shows a detail of a parking space area.

### DETAILED DESCRIPTION

The application relates to a method for ascertaining and/or managing a parking space map describing states of occupancy of parking spaces for a motor vehicle in a parking area in a motor vehicle-external server device.

To assist drivers of motor vehicles, a variety of support systems have been proposed which use, for example, software applications (apps) in order to provide drivers with pieces of information and services regarding parking spaces. The pieces of information provided are usually related to a local environment, thus based, for example, on a parking space map that includes a plurality of parking spaces. Thus, for example, drivers may be provided pieces of information such as the location of a parking space, prices for parking and/or opening hours. Pieces of information relating to parking spaces and parking environments may therefore be retrieved via a software application on the smartphone and/or via display devices in the motor vehicle. In addition, such software applications may be utilized, for example, to navigate to desired destination parking spaces and/or to pay parking fees. Such a software application may also indicate to a driver the availability of a parking space and/or of a parking environment, for example, a parking space or parking garage, in order to prevent the driver from driving to an already occupied parking space or to a fully occupied parking environment.

It has been proposed in the prior art to determine the availability, and thus the state of occupancy, of a parking space by ascertaining the location of the smartphone/of the motor vehicle when paying via a software application, according to which the parking space is marked as occupied for the time booked in a motor vehicle-external server device that manages the parking space map.

DE 10 2011 003 886 A1 proposes to provide a device for a vehicle for creating a piece of driving situation information, which device includes an evaluation unit for ascertaining a parking process of the vehicle by evaluating one or multiple driving state variables, and a communication unit for transmitting pieces of information about the ascertained parking process. Vehicle state data in this case may include a speed of the vehicle, an acceleration of the vehicle, a turn signal position of the vehicle, a steering wheel position of the vehicle, a gear selection position of the vehicle, navigation data and/or position data of a driver information system of the vehicle, surroundings data from surroundings sensors of the vehicle or driving situation data transmitted from other road users to the vehicle. It is apparent that a highly complex evaluation is carried out in order to provide, for example, infrastructure facilities with pieces of information that can be used for identifying parking space occupancy.

DE 10 2013 203 909 A1 relates to a method and a mobile terminal for detecting a parking space, wherein it is proposed to detect whether the mobile terminal is introduced into or leaves a motor vehicle, it being determined when leaving the motor vehicle whether the position indicates an occupied parking space, wherein a corresponding position is transmitted to a central server. Accordingly, when introduced in a motor vehicle, it may also be checked whether the position indicates a parking space and then a clearing is transmitted to the central server. This parking space in this case must already be known in a parking space map on the server.

Another possibility proposed in the prior art for ascertaining parking spaces is based on an interpretation of movement trajectories. For this purpose, GPS positions of smartphones on which a software application is installed as described above, are often used, but which are very inaccurate. Moreover, a smartphone is generally unable to determine with absolute certainty whether the vehicle has been parked. Thus, based on simple pieces of position information, it is possible to only conjecture whether a parking process has taken place.

Nor is this changed by a design in which a motor vehicle regularly, for example, every minute or every two minutes, sends its position to a motor vehicle-external server device, so that the server device is able monitor the flow of traffic and to identify congestion situations. The collected position data namely are chronologically so far apart as to render an analysis with regard to parking impossible; however, such a data reduction is necessary in order to reduce the amount of data being transmitted from the motor vehicle to the server device.

Thus, the object of the application is to specify an improved possibility for the position-based ascertainment and/or updating of a parking space map.

To achieve this object according to the application, it is provided in a method of the aforementioned kind that a position sequence covering a predetermined operating section of geodetic positions and/or positions relatable to geodetic positions that are visited by the motor vehicle, which position sequence is transmitted to the server device when a parking criterion indicating parking of the respective motor vehicle occurs, is recorded inside motor vehicles of a vehicle fleet communicating with the server, wherein the server device checks upon receipt of a position sequence, whether the position sequence describes a parking trajectory on a parking space that is managed or to be managed, and marks the parking space described by the final position in the position sequence as occupied when a parking trajectory is detected.

According to the application, it is therefore proposed to record positions inside motor vehicles at a high frequency, thus, at a significantly higher frequency than, for example, a position recording for ascertaining a piece of traffic position information, and to store the positions in a suitable memory device inside the motor vehicle. In this case, the position sequences that result from such a recording of positions relate to a predetermined operating section, for example, to a predetermined time interval, but preferably to a predetermined number of positions, thus allowing both the memory space and the transmission costs to be held to a minimum. In particular, only the positions relating to the operating section are then stored inside the motor vehicle. At the end of a drive, that is, when a parking criterion is met, indicating that the drive is completed, the last recorded, instantaneous position sequence is transmitted to the motor vehicle-external server device for further evaluation.

The change of frequency in the recording of positions compared to the ascertainment of a piece of traffic situation information then allows the trajectory at the end of the drive to be analyzed inside the server device, in order to determine whether a parking process has taken place. Parking trajectories have typical characteristics, depending on what type of parking process has been carried out. It may be determined, for example whether the motor vehicle has parked on the road or off the road, whether it has parked forward or backward and/or whether it has driven into a diagonal, longitudinal, or transverse parking space. In this case, it is particularly advantageous that position sequences recorded by the motor vehicle itself are used after the data from global navigation satellite systems are usually further refined there, for example, by map matching and/or by dead reckoning. Thus, it may be provided, in particular, that the positions are ascertained using a piece of position information of a sensor of a global navigation satellite system of the respective motor vehicle, preferably while being refined by map matching and/or by dead reckoning.

Based on the position sequence, a very reliable detection of a parking operation may thus be implemented. If it is then determined that a parking process has taken place, but the corresponding parking space in the parking space map is not yet known, the parking space may be added to the parking space map and accordingly be marked as occupied. If the parking space is already known, its status may be adapted accordingly.

The type of data proposed according to the application, i.e., the position sequence, and their analysis provide a very accurate parking space map, on which parking spaces and, as will be discussed in greater detail below, also their attributes and the state of occupancy may be accurately represented. In this case, only a few pieces of data need be held inside the vehicle and be forwarded accordingly after the drive. The approach according to the application described herein functions independently of external data sources, such as content providers and the like. However, it may also be used to supplement pieces of information from external data sources and to thus significantly increase the level of information.

In order to check whether the position sequence describes a parking trajectory, it is expedient to use at least one evaluation algorithm on the server device. For example, trajectory features of the trajectory described by the trajectory features may be extracted from the position sequence, for example, changes of direction, effected lateral offset, deviations from traffic routes and the like, so that a classification may take place. It is additionally or alternatively also conceivable to make comparisons with model trajectories for parking trajectories and the like.

In a particularly expedient embodiment of the present application, it is provided that positions in the motor vehicle are recorded cyclically, in particular at intervals of 0.5 seconds to 1.5 seconds, preferably one second, wherein the operating section is defined by a position number of positions to be stored, in particular 30 to 80 positions, preferably 50 positions. In one preferred embodiment, therefore, the instantaneous position may be ascertained, in particular, as a geodetic position, in the motor vehicle every second, and stored in the motor vehicle, wherein the length of the stored position sequence may be limited to 50 positions, for example. In this context, it is expedient to use a ring memory for storing the position sequence, in which the oldest position is always overwritten by the newest position recorded. Thus, with an instantaneously recorded position, the respectively oldest stored position is always overwritten as soon as the ring buffer is filled. Thus, a particularly simple implementation is provided.

One particularly advantageous embodiment in this context provides that in a stationary motor vehicle the cyclic recording of the positions is interrupted until the motor vehicle moves again. In this way, cases in particular are tapped, in which the parking criterion is met only after the parking process is clearly completed, for example if, for certain reasons, the driver allows the engine to run for some time or keeps the ignition active. In this embodiment, merely the depiction in the position sequence of the standing process in the parking space is then advantageously avoided. In this way, the data of the position sequence are reduced to the essentials.

A switch-off of an engine and/or of an ignition of a particular vehicle may be expediently checked as a parking criterion. Thus, the checking process may include, for example, the “terminal 15.” Switching off the engine and/or the ignition is therefore considered to be an indication of an end of the drive and thus of the operating phase of the motor vehicle.

One particularly advantageous embodiment of the present application provides that at least one additional piece of information, in particular, a parking direction and/or a parking position and/or a parking error, is ascertained by evaluating the position sequence. Apart from the fact whether a parking process has taken place, the parking trajectory described by the position sequence may also contain a large amount of additional pieces of information, in particular if additional pieces of information about the parking area are used, for example, digital map data indicating where traffic routes are located, the currently existing parking space map itself, which may contain previously collected pieces of information about the parking space, and the like. For example, it may be determined as an additional piece of information by additional analysis, whether it is a diagonal, longitudinal, or transverse parking space. Parking errors may potentially also be determined, for example, if the positions indicate that the driver of the motor vehicle is using two parking spaces simultaneously and/or is parked unlawfully on the sidewalk or the like. In the case of such a parking error, a communication may also take place, in particular, for the forwarding of corresponding pieces of warning information to the motor vehicle itself and/or to an office responsible for the parking space.

However, it may be provided, in particular, that a piece of description information to be assigned to the parking space is ascertained by, in particular, statistical evaluation of the piece of additional information. In particular, these may be attributes that describe the parking space more precisely. Thus, for example, not yet known parking spaces in the parking space map may also be equally provided with suitable attributes, as has already been indicated above with respect to the type of the parking space. In one preferred embodiment, at least part of the description information assigned to a parking space may also be transmitted to a motor vehicle which is parking or intends to park in the parking space, for example, information on how best to park in the parking space (“park preferably forward”) and the like. Such additional attributes may prove useful, in particular, when the parking process is to be at least partially automatically assisted by a vehicle system.

The description information or additional pieces of information may, in general, also be usefully evaluated elsewhere. For example, it may be determined, in particular by statistical evaluation of different parking trajectories, how complicated it is to park in a parking space, which may, for example, result in the necessity of structural changes to the parking space.

When a restart criterion for a parked motor vehicle is met, the last stored position sequence and/or a piece of identification information may preferably be transmitted to the server device again, which identifies the motor vehicle based on the position sequence and/or on the identification information and marks the corresponding parking space as available again. The restart criterion, like the parking criterion, may check, in particular, whether an engine is switched on and/or an ignition is switched on. Here, too, the check may refer to the terminal 15, for example. It is also particularly expedient to again forward the position sequence, which continues to be held in the memory device in the motor vehicle, since this represents a clear identification of the parking process and thus of the motor vehicle. In this way, the use of other pieces of identification information may be dispensed with. The server device may then, for example, compare relevant position sequences stored by the server device, in order to identify the motor vehicle and to know which motor vehicle has been restarted in order to be parked. The position sequence on the server device may then be deleted; However, it is expedient to still keep it in the vehicle, especially if the driver decides not to drive away despite a restart, but to leave the vehicle again, which will mean that the position sequence is again transmitted and the parking space would again be marked as occupied.

One expedient refinement in this context provides that a piece of usage information is ascertained for a parking space made available again, in particular, from the points in time of exiting a parking space and parking. A parking duration, for example, may be determined as usage information, once the process of exiting a parking space has been assigned to the parking process via timestamp, parking space, position sequence and/or identification information. The determination of pieces of usage information allows, in particular by statistical evaluation, the creation of an occupancy profile of the parking space, wherein parking spaces also belonging to a common parking environment may, in particular, be considered together in order to create an occupancy profile of the parking environment or the like.

Another particularly preferred embodiment of the invention provides that the server device also manages a traffic information map and the motor vehicles transmit an instantaneous position of the respective motor vehicle at regular intervals equalling at least ten times the time intervals of the positions of the position sequence, via the evaluation of which a piece of traffic situation information is ascertained on at least one traffic route of the parking space area. The central server device must therefore not only be used to manage the parking space map, but it may also manage a traffic information map, which indicates, for example, on which traffic routes a high volume of traffic/congestion is present and the like. For this purpose, it may be provided that the individual motor vehicles regularly, for example every minute or every two minutes, transmit their instantaneous position for the provision of such “traffic services” to the server device, which evaluates this position accordingly.

The server device may be variously designed within the context of the present application. Thus, the server device may be designed as a cloud and/or as part of a cloud, but it is also conceivable to design the server device as a backend computer.

A motor vehicle further refined for carrying out the method according to the application has at least one position determination device, one memory device, one communication device and one control device. The control device is designed to record and to store the position sequence in the memory device and to monitor the fulfillment of the parking criterion and optionally the restart criterion, thus, to perform all steps of the method according to the application necessary on the part of the motor vehicle. The memory device may be designed, in particular, as a ring memory and/or the position determination device may comprise a sensor of a global navigation satellite system (GNSS), in particular, a GPS sensor.

Further advantages and details of the present application will become apparent from the exemplary embodiments described below and with reference to the drawings,

in which:

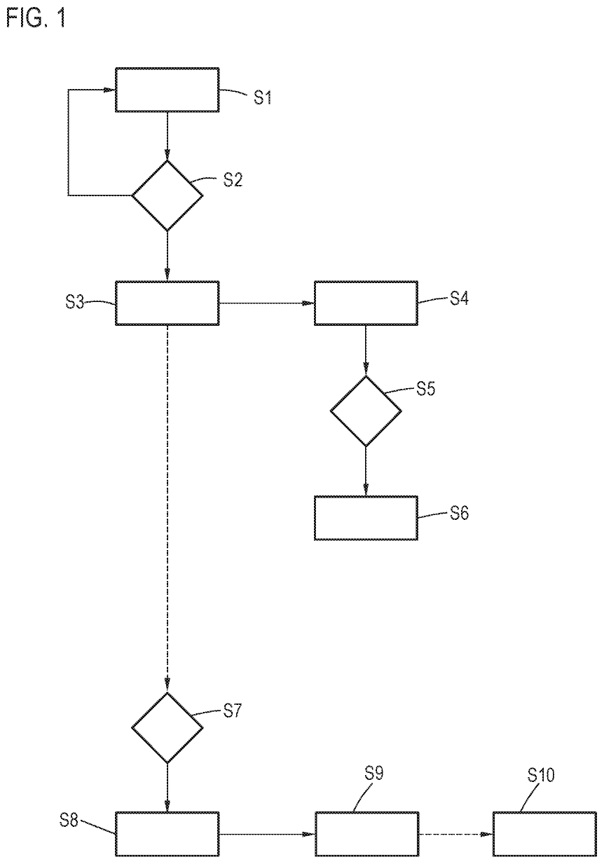

FIG. 1 shows a flowchart of one exemplary embodiment of the method according to the application, and

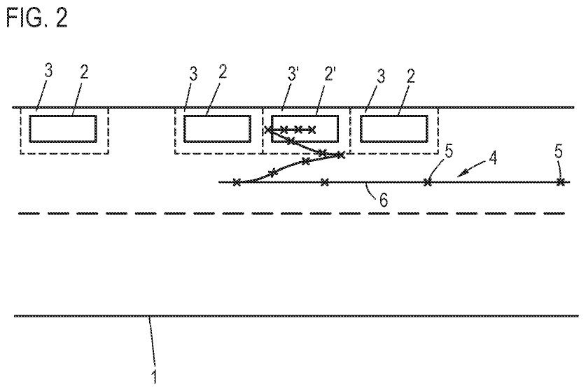

FIG. 2 shows a detail of a parking space area.

FIG. 1 shows a flowchart of one exemplary embodiment of the method according to the application. The steps on the left side of the flowchart take place in all motor vehicles of a motor vehicle fleet, which communicates with a central server device, the steps of which are shown on the right side.

During an operating phase of a respective motor vehicle, an instantaneous position of the motor vehicle is cyclically recorded in a step S1 by means of a position determining device of the motor vehicle and stored in a position list in a memory device of the motor vehicle. In the present case, the instantaneous position is determined as a geodetic position on the basis of position data of a GPS sensor of the motor vehicle; this position is refined by map matching and dead reckoning. The memory device is a ring memory, in which 50 positions may be stored. If a new position is stored, the oldest existing position is deleted accordingly. The storage of the instantaneous position in this case is, in principle, every second, wherein it is checked, however, whether the motor vehicle is even moving. If this is not the case, the storing is interrupted until the motor vehicle moves again. It may therefore be said that the position sequence in the memory device covers a 50 second movement of the motor vehicle.

In a step S2, it is checked by a corresponding control device of the motor vehicle, which also coordinates the recording of the position sequence, whether a parking criterion has occured, in this case, whether an engine of the motor vehicle is switched off. If the parking criterion is not met, the operating phase continues and further projection data are recorded in step S1; if, however, the parking criterion is met in step S2, the instantaneous position sequence is transmitted in a step S3 from the memory device by means of a communication device of the motor vehicle to a central server device, here a backend computer, and received there by means of a corresponding communication device.

An evaluation of the received position sequence takes place in the server device in a step S4, at least to the extent as to whether it represents a parking trajectory, and the end position of the transmitting motor vehicle must therefore be considered to be a parking space that is relevant for the parking space map managed in the server device. However, additional pieces of information, in particular, pieces of description information to be assigned to the parking space are also ascertained, in particular, whether it is a parking space across or along the street or a diagonal parking space, whether it is located at the edge of the street or away from the street and the like. For this purpose, existing digital map data in the server device, which characterize the traffic route network, are also taken into account.

If it is then determined in a step S5 that there actually was a parking trajectory, the parking space map, which relates to a specific parking space area, is updated in a step S6. If the parking position was not yet known in the parking space map as a parking space, the parking space is added accordingly, including corresponding pieces of description information, which ultimately represent attributes of the parking space. In any case, however, once the transmitting motor vehicle has parked in the parking space, the parking space is marked in the parking space map as occupied.

If parking errors have been detected as additional information, a piece of warning information may be correspondingly forwarded back to the motor vehicle and/or to a service.

It should also be noted that pieces of description information, which can be stored in the parking space map assigned to the parking space, may also be made available to motor vehicles, which are parking or intend to park in the parking space.

These steps will be explained in greater detail with reference to FIG. 2. Shown there is a street 1, along which motor vehicles 2 are parked in parking spaces 3. Lastly, the motor vehicle 2′ has been parked in the parking space 3′, wherein the position sequence 4 based on the positions 5 recorded in each case at an interval of one second and the resulting trajectory 6 are shown. It is clearly a classic parking trajectory for parking in a parking space 3′ oriented the same as the street 1. In this case, the driver has parked in three moves. Corresponding characteristics of the trajectory 6 may be recognized in the server device, so that the trajectory 6 may be recognized as a parking trajectory and it may be determined accordingly that the motor vehicle 2′ has been parked in a parking space 3′ and that it is oriented longitudinally in line with the road.

In addition, position sequences and derived pieces of additional information with regard to the parking spaces 3 may also be statistically evaluated, for example, to the extent as to whether it is particularly difficult to park in the parking space 3, so that, for example, structural changes are indicated.

Returning to FIG. 1, it is then regularly checked in the motor vehicle 2 by means of the control device in a step S7 whether a restart criterion is met, which indicates that a new operating phase of the motor vehicle 2 is starting and it is expected to exit a parking space. For this purpose, it is again checked at terminal 15, whether the engine is started. If this is the case, the position sequence is transmitted again to the server device by means of the communication device in step S8, where in a step S9 an assignment as identification information takes place by comparing the position sequences and the parking space 3 is accordingly again marked in the parking space map as available. Furthermore, another evaluation for ascertaining an occupancy profile of the parking space 3 also takes place in a step S10. For this purpose, the parking duration, in particular, is determined.

Moreover, as generally known, the parking space map may be utilized in a variety of ways, in particular in connection with parking assistance services, which are able, for example, to assign free parking spaces, navigate to these, handle payment in an automated manner, and the like.

It should also be noted that the server device in this exemplary embodiment also serves to ascertain a traffic information map, so that the motor vehicles transmit their instantaneouos position cyclically, in this case at intervals of one minute regardless, which positions may then be evaluated in order to ascertain a piece of traffic situation information which indicates, for example, the presence of congestion on traffic routes of the parking space area covered and the like.

1.-11. (canceled)

12. A method for determining or managing a parking space map, wherein the parking space map describes states of occupancy of parking spaces for a motor vehicle in a parking space area, the method comprising:
recording, by a control device of the motor vehicle, a position sequence covering a predetermined operating section of the geodetic positions or positions relatable to the geodetic positions that are visited by the motor vehicle;
determining, by the control device of the motor vehicle, a parking criterion indicating an occurrence of parking of the motor vehicle;
transmitting, by a communication device of the motor vehicle, the position sequence to a server device;
determining, by the server device, whether the position sequence describes a parking trajectory on a parking space in the parking space area; and
marking as occupied, by the server device, a parking space described by a final position in the position sequence in response to determining the position sequence describes the parking trajectory on the parking space.

13. The method according to claim 12, further comprising recording the position sequence of the motor vehicle cyclically, wherein the predetermined operating section is defined by a number of position to be stored.

14. The method according to claim 13, wherein recording the position sequence uses a ring memory configured to overwrite an oldest recorded position by a latest recorded position.

15. The method according to claim 13, wherein recording the position sequence is paused if the motor vehicle stops moving.

16. The method according to claim 12, further comprising determining the geodetic positions using a piece of position information of a sensor of a global navigation satellite system of the motor vehicle, wherein the geodetic positions are refined by map matching or dead reckoning.

17. The method according to claim 12, wherein the parking criterion includes a switching off of an engine or of an ignition of the motor vehicle.

18. The method according to claim 12, further comprising determining a parking direction or a parking position or a parking error by evaluating the position sequence.

19. The method according to claim 12, further comprising determining a piece of description information to be assigned to the parking space through statistical evaluation.

20. The method according to claim 12, further comprising:
determining, by the control device of the motor vehicle, whether a restart criterion for the motor vehicle is met;
transmitting, by the communication device of the motor vehicle, a most recently stored position sequence or a piece of identification information to the server device;
identifying, by the server device, the motor vehicle based on the most recently stored position sequence or the identification information; and
marking, by the server device, the parking space occupied by the motor vehicle as available.

21. The method according to claim 20, further comprising determining a piece of usage information for the parking space between the points in time of parking and of exiting the parking space.

22. The method according to claim 12, further comprising:
managing, by the server device, a traffic information map;
transmitting, by the communication device of the motor vehicle, an instantaneous position of the motor vehicle to the server device at regular intervals; and
determining, by the server device, a traffic route to the parking space area by evaluating a piece of traffic situation information, wherein the regular intervals are at least ten times longer than time intervals of the geodetic positions of the position sequence.

23. A server device configured to determine or manage a parking space map, wherein the parking space map describes states of occupancy of parking spaces for a motor vehicle in a parking space area, the server device further configured to:
receive a position sequence covering a predetermined operating section of the geodetic positions or positions relatable to the geodetic positions that are visited by the motor vehicle from the motor vehicle in response to an occurrence of a parking criterion indicating parking of the motor vehicle;
determine whether the position sequence describes a parking trajectory on the parking space area; and
mark a parking space described by a final position in the position sequence as occupied.
